(19) United States
(12) Patent Application Publication
(10) Pub. No.: US 2017/0280535 A1
(43) Pub. Date: Sep. 28, 2017

(54) SYSTEM FOR SELECTIVE ELECTRONIC MEMORIAL CANDLE ILLUMINATION

(71) Applicant: Gabor Lederer, Clifton, NJ (US)

(72) Inventor: Gabor Lederer, Clifton, NJ (US)

(21) Appl. No.: 14/844,016

(22) Filed: Sep. 3, 2015

Related U.S. Application Data
(63) Continuation-in-part of application No. 13/296,206, filed on Nov. 14, 2011, now abandoned.
Application No. 13/296,206 is a continuation-in-part of application No. 10/666,731, filed on Sep. 19, 2003, now Pat. No. 7,011,426.
(60) Provisional application No. 60/453,611, filed on Mar. 11, 2003.

(51) Int. Cl. H05B 37/02; G06Q 30/06

(52) U.S. Cl. CPC H05B 37/0245; H05B 37/029; G06Q 30/0641; H05B 37/0281

(57) ABSTRACT

A system for the selective illumination of electronic memorial candles in a memorial display of a publicly viewable array of physical electronic candles at a religious or memorial site. The array of candles is electronically connected to a single computer configured to interelationally control illumination of all the candles in the array with selective candle illumination of one or more candles in the array and duration of the illumination of the selected candles. A payment validator instructs the computer to accept validated payment in the form of physically deposited paper currency, credit card or debit card charge or an electronic fund transfer from an existing account. When payment is validated the computer actuates the selected candle for illumination by a user or directly illuminates the selected candle or candles for the selected candle or candles for the paid for duration of time.

This application is a continuation-in-part of U.S. Ser. No. 13/296,206 filed Nov. 14, 2011, which is a continuation-in-part of U.S. Ser. No. 10/666,731, filed Sep. 19, 2003, which claims priority to provisional application Ser. No. 60/453,611, filed Mar. 11, 2003, which applications are incorporated herein in their entireties by reference thereto.

### BACKGROUND OF THE INVENTION

Field of Use

This invention relates to electronic candles used at religious sites such as churches and synagogues and for memorials at sites such as cemeteries and also relates to electronic candles used at such sites wherein payments are made for lighting the candles for a certain period of time in support of the religious or memorial site organization.

Discussion of the Background and Prior Art

Traditionally, wax candles, such as votive candles and tapers, have been used for memorialization and devotional purposes and are arranged in large public viewable arrays. Religious institutions generally provide for the purchase and lighting of the wax candles, which are placed in designated areas in the large arrays. Purchasers of the candles generally make a donation of a desired or recommended amount, which amount is usually deposited in a collection box in order to acquire and light the wax candle.

Wax candles however produce excessive amounts of heat, pollutants and soot, are a fire hazard. Insurance is costly where wax candles are in general use, particularly when openly displayed in the large arrays. Accordingly, safer electronic candles, have become increasingly more popular. With these candles the user “turns-on” a candle which then illuminates. However, unlike wax candles which have a finite fuel life and are discardable, electronic candles which are designed for multiple sequential uses, require time limits to enable memorial lightings to be separately and sequentially available. Basic electronic candles include those disclosed in U.S. Pat. Nos. 6,066,924; 6,017,139; 5,863,108; 4,617,614 and U.S. Publication Application 2004/0179355. Electronic candles geared for operation with payment and restricted time use include Cavalleri (U.S. Pat. No. 4,228,885), which discloses a single mechanically operated electrical light, which is illuminatable for a mechanically determined time (spring timer) with a dropped coin of specific type and value which both activates a switch and pays for the lighting. Shin et al. (U.S. Publication Application 2002/0013713) is exemplary of internet usage and personal display, with a virtual image rather than an actual physical candle, with the image of a single candle being made visible only to the internet viewer and not the public and to only a person having access to a particular commercial web site.

Prior art methods of electronic candle lighting are not amenable to candle selection from a publicly available array, where candle preferences can be made. Such preferences include better visibility (especially for a purchased memorial candle where public display and visibility is the primary purpose) or if the candle stand is in front of a statue and a side position is preferred while some just have a preferred side or row. Furthermore, the prior art electronic candles do not adequately control the payment for the illumination and provide no time limit selectable options for selecting specific illumination time intervals, and are unsatisfactory as a revenue source to both the religious institution and the electronic candle manufacturer. In the prior art, in general, activation of an actual albeit electronic candle for illumination has required the direct presence of either the user-purchaser or a representative person to effect a requisite payment and/or to light a selected candle once payment has been made. In addition, prior art electronic candles have invariably been individual in nature and individually controlled and maintained with marked inefficiency in candle selection, control and operation. Money must be collected from the use of each candle individually rather than with a more efficient overall collection.

### SUMMARY OF THE INVENTION

It is therefore an object of the present invention to provide a system and method for the controlled illumination of electronic memorial candles, wherein the electronic candles are provided and maintained for public view at religious and/or memorial sites and institutions with an overall unitary and interrelational mechanism for illuminating candle selection, control and relative operation.

It is another object of the present invention to provide automated collection and pilfer control for the aforesaid electronic candles, particularly for religious institutions.

It is still yet another object of the present invention to provide an electronic candle lighting system, particularly for religious and/or memorial type purposes, which can be remotely paid for by any of cash or credit or debit cards or charged to accounts and activated and with optional provisions for remotely visually selecting a particular electronic candle or candles and for providing receipts for payments. Remote controlled generation of memorial designations are enabled for the printing or generation of personalized indicia which can be placed on selected lit electronic candles.

It is another object of the present information to provide the remotely activated memorial electronic candles at memorial sites, such as cemeteries and mausoleums, with remote visual viewing or confirmation of the lit electronic candles.

It is another object of the present invention to provide the electronic candle or candles with generated accounting data including gathering of the duration of lighting times of the individual or groups of candles and payments being made, with optional data with respect to which electronic candles and positions are more favorable for income generation.

Generally the invention, in a first embodiment, comprises a system for the physical selective illumination of electronic memorial candles in a memorial display of an array of electronic candles at a religious or memorial site. The system comprises a physical publicly displayed and publicly viewable array of electronic candles electronically connected to a single computer controller element with the computer controller element being configured to interelationally control illumination of all the candles in the array with selective candle illumination of one or more candles in the array and duration of the illumination of the selected candles.

The computer is provided with operational instructions to accept validated payment in the form of physically deposited paper currency, credit card or debit card charge or an electronic fund transfer from an existing account. Payment for the illumination is provided as a quasi-donation to the site for the privilege thereof and for support of the site organization. When payment is validated (with respect to both available payment wherewithal and a valid user) the computer actuates (making the candle “live for illumination” or illuminates (when the payer is remote from the site of the candle site and cannot physically actuate the candles) at least one candle of a plurality of candles. The computer uses a determined amount of payment made, to maintain a live actuated state of selected candles for a predetermined and prescribed time limit.

After the candle is actuated for illumination, the user touches or otherwise activates each selected candle to effect illumination for the prescribed time period. This step is dispensed with if the computer itself is instructed to effect the requisite illumination(s). A chart or other visual means may be used to inform the user of the cost and committed illumination time period in order for the user to make an informed decision regarding payment. A currency validator or credit card payment validator senses the payment amount sends an electronic signal to a control unit or central unit wherein the illumination time is calculated, and in turn, an electronic signal is transmitted to the candles to actuate the candles for the prescribed time corresponding to the payment. The user touches (or otherwise activates a switch) a desired selected candle, which is, by such touching, illuminated for the prescribed period. With illumination of the one selected candle, the remaining unlit candles are de-actuated by the computer with its interrelational control of all the candles in the array. The system is made for each present or subsequent user—purchaser to make accurate payment and effect illumination of the related electronic candle.

The system induces encrypted or means for automatically providing encoded account statement of the candles illumination times and the corresponding payments represent those illuminations. The manufacturer of the electronic candles decrypts the account statement for confirming royalty or lease payments.

A stand is provided for mounting the candles in an arrangement. This arrangement provides the user with a diverse selection of positions from which to select the candle for illumination. The candles may also contain different indicia. This permits the user to select a candle that is most consistent with their devotional, memorial or emotional needs and desires.

In another embodiment, the candle or array of candles is completely remotely accessible for payment and activation. In addition, the system may include a remote video view of the candle array in order to provide a visual selection of a desired (or non-previously lit candle) for specific selection of a candle to be lit. The visual video view also provides a real time confirmation of the actual lighting of the candle or candles. The remote view may be accessible at a specific location such as a neighborhood church or synagogue or it may be accessible on-line via an intra or internet hook-up and access.

The system optionally includes the capability of either remotely or locally printing or otherwise generating memorial or other indicia suitable for placement on a selected candle or candle as an indication of the actual memorialization for which the candle is being lit. This option is generally suitable for candles, which are lit for relatively long term durations.

In addition to the account statement generated for the purpose of royalty and leas payments, it is also preferred that the system includes a running compilation related to each candle or groups of candles. The compilation includes date, time and duration of the lighting of each of the candles individually and collectively, as well as a running compilation of generated income with related time and sources of the income. This data is used for estimating expected income and how to maximize income by controlling placement of candles and candle systems.

### BRIEF DESCRIPTION OF THE DRAWINGS

FIG. 1 is a block diagram showing the prior art method of electronic candle illumination at a religious institution.

FIG. 2 is a block diagram of the overall system of the present invention;

FIG. 3 is a detailed block diagram of the candle illumination system;

FIG. 4 is a schematic depiction of a remote selection, payment and activation of candles with a video real time remote viewing of the candles for selection and confirmation of lighting;

FIG. 5 is a schematic depiction of the generation of a sleeve for the electronic candle with memorial indicia thereon;

FIG.6 is a typical computer screen generation menu selection of candle lighting durations, fees and payment options; and

FIG. 7 is a computer screen representation of the actual physical candle array display showing already lit candles and available unlit candles currently available for selection for illumination selection.

### DESCRIPTION OF THE INVENTION

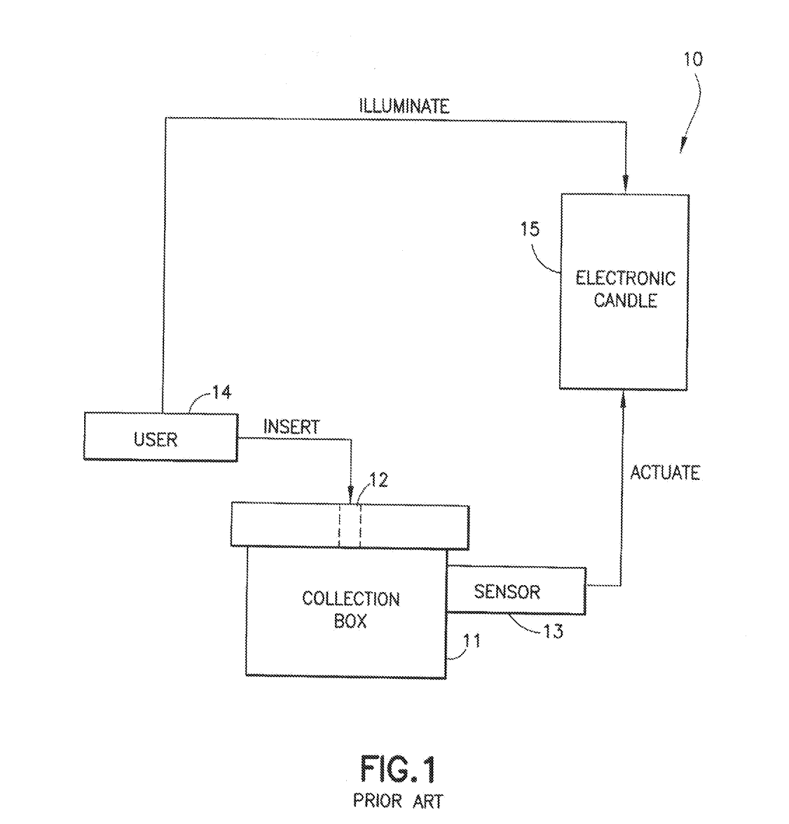

Referring to FIG. 1, there is shown a prior art electronic candle illumination system 10. System 10 is based on a collection box 11 having slot 12 of conventional construction. An object motion sensor 13 is mounted in the side of collection box 11. The user 14 inserts any object, e.g., coins, paper currency, token, paper, medals and the like, into slot 12. The sensor senses the object and in turn actuates at least one electronic candle 15 for illumination. Each candle is provided with its own activation mechanism and is separate from other candles in terms of control, interaction and payment. The user then turns on the specific electronic candle 15 of his/her selection. This system did not provide a viable system for candle illuminations, particularly for religious institutions and memorialization forums, e.g. cemeteries and memorials.

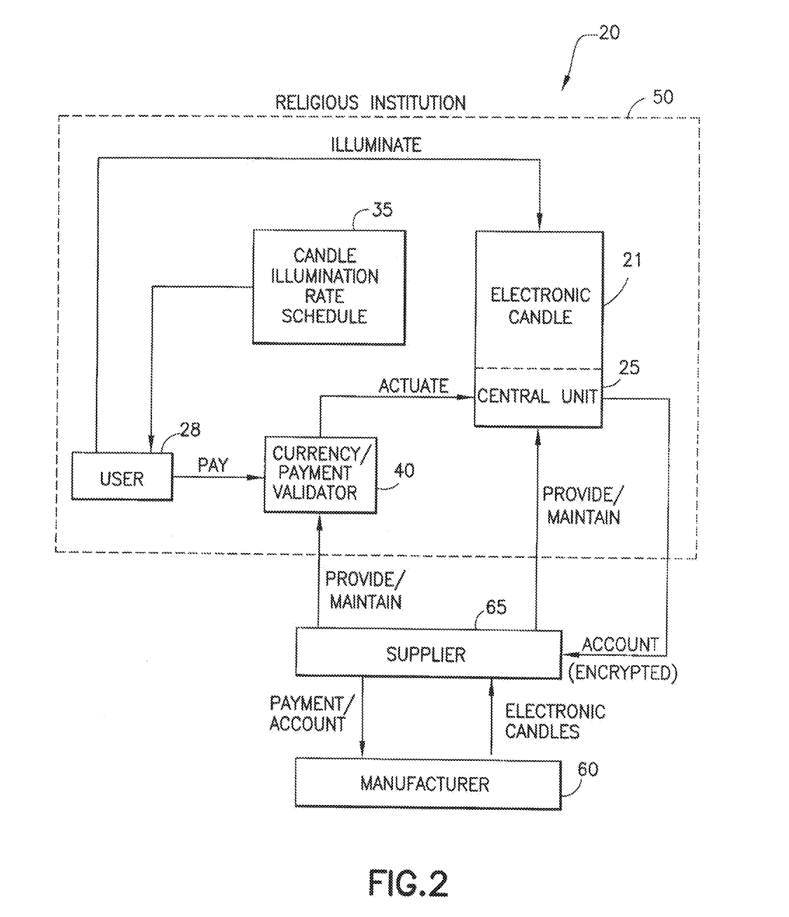

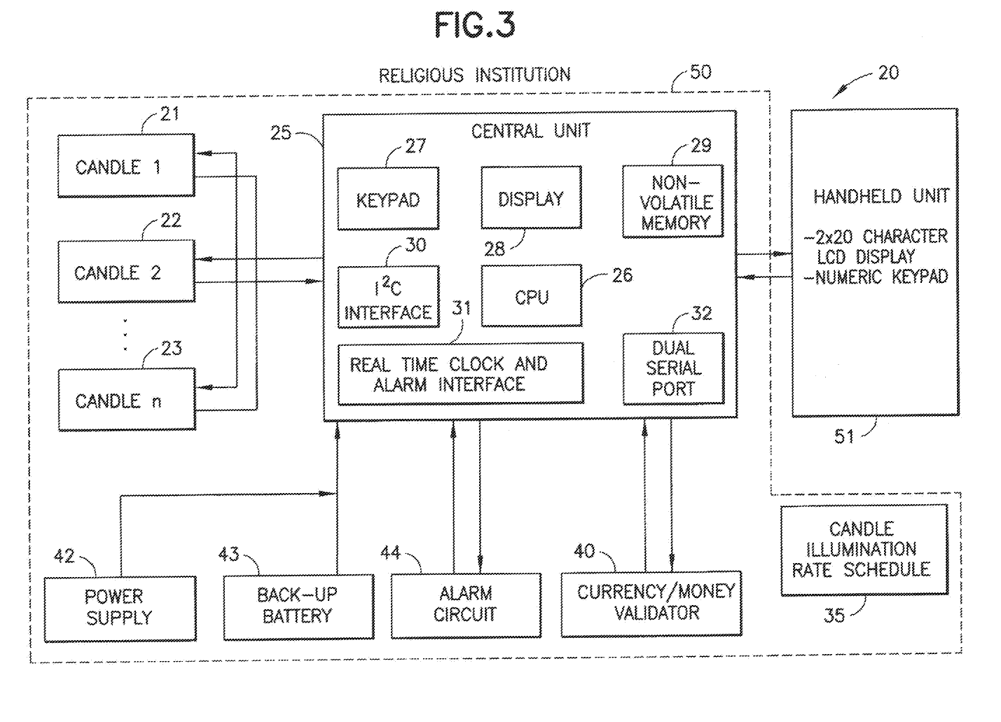

Referring to FIGS. 2 and 3, there is shown the system for the illumination of electronic candles 20 of the present invention. System 20 includes an array of a plurality of electronic candles, e.g. 21, 22 and 23. Electronic candles 21-23 imitate traditional wax candles, such as a votive or memorial candle. A central unit or control unit 25 controls illumination of all the candles in the array as well as on an interrelational basis. Candle illumination selection is supplied to the central control unit 25 via input devices such as keypad 27. Duration of individual candle illumination times is also controlled by the central control unit 25. Central unit 25 includes a CPU 26, the aforementioned keypad 27, display 28, non-volatile memory 29, I²C interface 30, real-time clock and alarm interface 31 and a dual serial port 32. The components 26-32 are assembled and programmed by means well known to one skilled in the control system art. It is understood that specifics of such components is exemplary and that changes may be readily made in accordance with existing technology.

A currency/payment validator 40 is electronically connected to the central control unit 25 and provides instructions thereto regarding valid illumination and duration time for the selected candle(s). Currency/payment validator 40 may be of conventional design and construction wherein a bill in any one of several denominations is inserted in a slot (not shown) in currency/payment validator 40. The inserted bill is acknowledged by an alpha-numeric display or illumination element (not shown). The inserted bill sends an electronic signal to central unit 25. A candle illumination rate schedule 35 advises the user 28 as to the illumination time for a prescribed payment. The electronic signal from currency/payment validator 40 to central unit 25 informs the central unit of the candle illumination period for which the prescribed payment was made. Central unit 25 in turn actuates candles 21-23 (as selected) for that prescribed illumination period. The user 28 then touches a selected candle, e.g. 21 and in so doing, illuminates the selected electronic candle for the prescribed time period.

A power supply 42, back-up battery power source 43 and alarm circuit 44 complete the assembly provided to and maintained at religious institutions 50. A hand held unit 51 may be plugged into central unit 25 for the purpose of recording the illumination times and/or payments mode. This account function may be encrypted in or encoded by central unit 25. A manufacturer 50 may retain decryption means to read the encrypted account information. The encrypted account information may be stored on a hand held device provided by manufacturer 50. A supplier 65 is under contract with the manufacturer to provide and manufacture the electronic candle 21-23, central unit 25 and currency/payment validator 40, as well as to take periodic account ready by means of hand held device 51, permit to a contractual arrangement with the manufacturer 50 and the religious institutions.

The present system 20 is provided on the aforesaid manner, which operation is desired is further discussed hereinafter.

One preferred electronic candle useful in the present invention is that shown and described in U.S. Pat. No. 6,017,139 granted Jan. 25, 2000 to Gabor Lederer, the invention herein, which disclosure is incorporated in its entirety herein by reference thereto. This electronic candle includes a spring loaded switch and timer element, wherein the user merely touches or presses down on the candle housing to effect illumination for the prescribed time period. In the present invention, the electronic candle is only first actuated after the currency/payment validator 40 validates the actual and correct currency payment or donation. Touching or otherwise manipulating the selected illuminated electronic candle will not interfere with the continue illumination for the payment prescribed period of time.

When currency/payment validator 40 senses a non-counterfeit bill and determines its face value, an electronic signal commensurate with the face value of the bill is sent to the central unit 25. The central unit calculates the prescribed illumination time for the currency value of that bill. The central unit then enters an electronic “ready to turn on” signal to every candle 21-23. The user then selects and turns on the selected electronic candle by pressing the top of the candle housing. This illumination of the candle will also send a recognition signal to the central unit 25. The recognition signal identifies the illuminated candle and the first of the illumination, as well as the illumination time. This information is stored in the central unit memory. The central unit then sends a “not ready” or “disabled” signal to the other candles. None of the other candles can be turned on until a new “ready to turn on” signal is generated. The central unit 25 tracks the illumination history of every candle. After the prescribed illumination time has elapsed, the central unit 25 sends a “turn off” signal to the afore-discussed illuminated candle. In order to insure user recovery in the event of power failure, every illumination start time and illumination lapse period is stored in the instrument, and updated in a non-volatile memory 29 every ten milliseconds.

The currency/payment validator 40 can recognize different bills. Validation is set for the customary are the $1, $5, $10 and $20 bills. The currency/payment validator 40, however, may be set for any currency including foreign currency in diverse face values. The operator or religious institutions are able to dedicate any time interval to any bill value and store them in the memory of the CPU through push-buttons and LEDs displays (on the front panel of the unit). By pressing the “$” and up/down sets the dollar value (upper display), by pressing only the up/down, the time can be set (lower display), pressing “Enter” the desired (set) values will be stored. By pressing “Check” and the “$” button, the displays will show the currently existing settings. By pressing “Check” and the up/down button, the current time setting can be displayed. The moneys collected since the last reading (or collection) can be read by pressing “Enter” and “Check” buttons. The sum total amount that shows should have been collected and disposed in the money collection box at that time since the collection box was last emptied. To restart this type of counting (from collection to collection), press “Enter” and “Check” again. The total amount of the collected moneys can be read in a coded form only by pressing the “check” button. In this mode, the displays (upper/lower) will show a combination of numbers and letters. Inserting the numbers/letters will decode them to a real dollar value. This amount is the total collection from a pre-set time (factory set or password protected settings) and is achieved by a separate program.

[t is understood that the above example and drawings are merely exemplary of the present invention and that changes in the method, system and apparatus and afore-discussed may be made without departing from the scope of the present invention as defined in the following claims.

It is an unfortunate fact of present reality that church collection boxes are pilfered. The electronic candle art desires a commercialization system with automated collection accounting and pilfer control.

In the present invention, there is provided a counter operably connected to the currency/payment validator 40 by electro-mechanical means well known in the art. When the collection box is opened, the counter records the date and time of the opening and the currency accumulated in the collection box since the last opening. This information is provided to the religious institution, the supplier and/or the manufacturer by electronic transmission means well known in the art. Non-wireless communication is also within the contemplation of the present invention. This collection box accounts information may also be encoded by the central processing units. A decryption means may be provided to the religious institution, supplier and/or manufacturer, whereby the electronically determined accounts and the physically accumulated monies are reconciled. In the event that any one collection does not correlate with the electronic accounts, the religious institution is able to identify the specific collector responsible for the deficient collection. The electronic accounts also permits a ready determination regarding distribution of the collected monies among the religious institutions, suppliers and manufacturer.

The automated system also contemplates providing an accounting for a pre-selected period of time, e.g. a month or a year, coins with the terms of commercialization between the manufacturer and the religious institution. As described above, the automated system further provides detailed data for the specific candles or groups of candles, of specific lighting times, duration and expected. Income to be generated to provide a planning basis for the installation of the candle systems at various location. Remote Candle Selection, Payment and Action with Remote Viewing

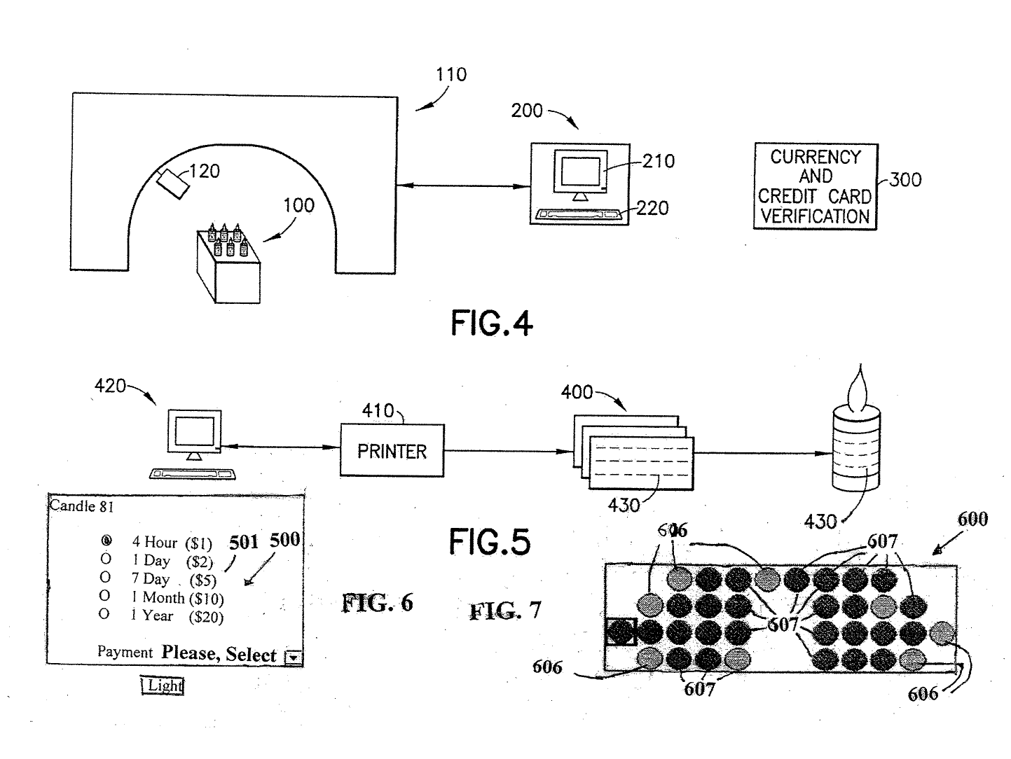

As seen in FIG. 4, an electronic candle array is positioned in an area of a mausoleum visible by visitors. The candle array is electronically connected for remote payment and activation whereby a person at a remote location can view the array via camera in real time. The person is then directed to pay a selected fee for activation of one or more candles for a specific period of time. Payment is made remotely by credit or account information or, if at an established remote location, via the currency and credit card verification system, as described above, located at such remote location.

Verification of the candle lighting is then made remotely via the same camera by which selection was initially made.

FIG. 5 depicts the optional, whether remotely or locally, generation of a sleeve for a selected candle with memorial or similar indicia thereon (payment is similarly made for such optional service). The printed sleeve is then placed on the selected lit candle as a display showing the person or reason the candle is lit. With extinguishing of the candle, an attendant removes the sleeve(s) for either storage or disposal.

FIG. 6 is a screen shot 500 of a candle payment time 501 and payment selection 502 for a first candle. Subsequent screens (not shown) provide for particulars of the type and details for actual payments. Once payment has been effected, the screen in FIG. 7 is displayed with a representation 600 of the publicly visible physical candle display with relative candle placement. White circles 606 represent candles and positions which have been and are currently illuminated and not available for selection. Dark circles 607 represent candles, which are available for illumination. Either the screen is a touch screen and a selected circle is touched for selected illumination thereafter (either physically or by computer control) of the corresponding candle on the physical display or a pointing device (e.g. computer mouse) is used to effect the desired selection. This process is repeated for multiple selections with the representations of the prior candles being changed on the screen to not available and prevented from being re-selected while illuminated (or selected for illumination).

It is also within the contemplation of the present invention for the manufacturer to provide the services and activities of the supplier.

It is also within the contemplation of the present invention for the religious institution to purchase the electronic candles from the manufacturer and operate and collect information by itself and have the manufacturer service the electronic candles and the automated controls and accounting.

1. A system for the selective lighting and illumination of memorial electronic candles from an array of candles, comprising:
i. an array of a plurality of physical electronic candles physically located at a memorial site or house of worship,
ii. a computer electronically connected to all the electronic candles of the array of the plurality of physical candles and configured to selectively control the lighting of the physical candles;
iii. a candle selection interface for instructing the computer to process illumination of at least one candle selected from the array for a selected period time and for payment thereof; and
iv. a payment validator linked to the computer and candle selection interface configured to validate or reject payment based on criteria of valid payment and authorized user;
wherein each candle is computer controlled for locally or remotely selectively illuminating selected candles in the array, and wherein the computer is configured for disabling remaining non-selected candles, with illumination of the selected candle, and the computer is configured for validating and accepting any of a debit or credit card payment from a user, either locally or remotely, desirous of illuminating one selected candle in the array and a paper currency payment of an amount up to the value of the paper currency of a selected time and vale, and configured for electronically validating and accepting the payment to the plurality of electronic candles, wherein, with validation and acceptance of the selected payment amount the one candle only is actuated for a predetermined time of illumination and is visible with such illumination within the array, with the predetermined time of illumination being commensurate in duration with a predetermined value of the payment being accepted.

2. The system of claim 1, further being configured for automatically discontinuing illumination of the selected illuminated candle after the pre-determined time.

3. The system of claim 1, wherein each physical electronic candle includes at least one LED for the illuminating thereof.

4. The system of claim 3, wherein the electronic candles are not powered for actuation prior to validation and acceptance of payment.

5. The system of claim 4, wherein with local selective illumination of the physical candles selective illuminating of a candle is effected by a switching member in the system configured for illumination of the selected candle with a touching of the selected candle by the user.

6. The system of claim 1, wherein with remote selection, the system further comprises a video camera viewer configured to remotely take continuous real time images of the array of physical candles including a physical electronic candle to be illuminated with a remote real-time view of the physical electronic candles prior to illumination for selecting of non lit candles for illumination and a remote real-time view of the physical candles after illumination within the array, as verification of the illumination of the selected physical electronic candle among the plurality of electronic candles in the array.

7. The system of claim 1, said plurality of candles being disposed at a first location, and an element configured for accounting of the validated payment being remotely disposed at a second location.

8. The system of claim 1, wherein said element for accounting for the validated payment of the selected electronic candle comprises a keypad.

9. The system of claim 1, wherein collection of payment for illumination is centrally located wherein placed donations activate selected candles the selected and paid for time of illumination.

10. The system of claim 1, wherein the system includes a residual memory wherein power outages which shut down the system is configured to retain previously set settings and effect continuation of illumination operation, when power is restored, until the set time expires not including interruption time.

11. The system of claim 1, wherein collected financial information relating to the payments is accessible locally or remotely on the interne by an authorized user.
